(19) United States
(12) Patent Application Publication
(10) Pub. No.: US 2026/0223990 A1
(43) Pub. Date: Aug. 6, 2026

(54) SURFACE FASTENER MANUFACTURING METHOD AND SURFACE FASTENER

(71) Applicant: YKK Corporation, Tokyo (JP)

(72) Inventors: Isamu Michihata, Toyama (JP); Yui Miyawaki, Toyama (JP); Wataru Kuriyama, Toyama (JP)

(21) Appl. No.: 19/147,392

(22) PCT Filed: Jan. 30, 2023
(86) PCT No.: PCT/JP2023/002900

§ 371 Date: Jul. 11, 2025

(51) Int. Cl. A44B 18/00

(52) U.S. Cl. CPC A44B 18/0049; A44B 18/0061

(57) ABSTRACT

A method for manufacturing a surface fastener includes a molding step of molding the surface fastener by feeding a molten synthetic resin into a mold in which cavity spaces are provided, a separating step of separating engaging elements from the cavity spaces, and a distortion-removing step of deforming the engaging elements by heating the separated engaging elements to remove distortion generated in the engaging elements. This enables manufacturing of a surface fastener made of a synthetic resin containing a saturated polyester resin as a main component and not including a factor that impedes recycling of the saturated polyester resin.

### TECHNICAL FIELD

The present invention relates to a surface fastener manufacturing method and a surface fastener.

### BACKGROUND ART

Hitherto, there has been known a surface fastener product in which a loop member having a plurality of loops (female surface fastener) and a male surface fastener attachable to and detachable from the loop member are used in combination. The male surface fastener is also referred to as a hook member. It should be noted that, in the following description, a male surface fastener is simply abbreviated as a “surface fastener”, and a description of a surface fastener means a male surface fastener. The surface fastener includes, for example, a flat-plate-shaped base portion and a plurality of engaging elements provided integrally on the base portion and protruding from the base portion.

For example, Japanese Unexamined Patent Application Publication No. 2020-28381 (PTL 1) describes a surface fastener used in products such as clothing. PTL 1 discloses that, for example, a thermoplastic resin such as polypropylene, polyester, nylon, polybutylene terephthalate, or a copolymer thereof is suitably employed as the material of the surface fastener.

### CITATION LIST

### Patent Literature

### PTL 1: Japanese Unexamined Patent Application Publication No. 2020-28381

### SUMMARY OF INVENTION

### Technical Problem

In recent years, in view of environmental protection, resource saving, etc., efforts to recycle synthetic resins (plastics) and the like have been expanding; for example, clothing such as used clothing is collected, and synthetic resins such as polyester resins are recycled from the collected clothing. Moreover, in recycling of synthetic resins, in order to reduce the environmental load as much as possible, to improve the efficiency of recycling, etc., mono-materialization in which a product is formed using a single material is progressing; for example, in recycling of clothing and the like, it is desirable to utilize a polyethylene terephthalate resin (hereinafter abbreviated as a PET resin), that is, to form the entire product by using a single material of a PET resin.

Meanwhile, for a known surface fastener described in, for example, PTL 1, the surface fastener is usually formed by using a synthetic resin containing an elastomer (for example, a polyester elastomer or a polyurethane elastomer) or the like considering that, for example, a molten synthetic resin is smoothly extruded, and a molded body molded in a mold is easily taken (or easily separated) from the mold in a manufacturing step of the surface fastener.

However, in recycling of synthetic resins, many impeding factors that impede recycling are known; for example, in a case where products made of a saturated polyester resin (in particular, a PET resin) are recycled, an elastomer contained in known surface fasteners is one of the factors that impede recycling. Therefore, in products to which a surface fastener is attached, such as clothing, in order to realize mono-materialization of products made of a saturated polyester resin (in particular, a PET resin), there has been a demand for the development of a surface fastener made of a saturated polyester resin not including a factor that impedes recycling, such as an elastomer.

The present invention has been made in view of the problem described above, and an object thereof is to provide a manufacturing method that enables manufacturing of a surface fastener made of a synthetic resin containing a saturated polyester resin (for example, a PET resin) as a main component and not including a factor that impedes recycling of the saturated polyester resin, and a surface fastener manufactured by the manufacturing method.

### Solution to Problem

A surface fastener manufacturing method provided by the present invention to achieve the aforementioned object is a surface fastener manufacturing method in which a surface fastener made of a synthetic resin is manufactured, the surface fastener including a base portion and a plurality of engaging elements provided on the base portion, the engaging elements each having a stem portion protruding from the base portion and an engaging portion located at a leading end portion of the stem portion, the surface fastener manufacturing method being characterized by including a molding step of molding the surface fastener by feeding the molten synthetic resin into a mold in which cavity spaces are provided; a separating step of separating the engaging elements from the cavity spaces; and a distortion-removing step of deforming the engaging elements by heating the separated engaging elements to remove distortion generated in the engaging elements after the separating step.

The surface fastener manufacturing method according to the present invention preferably includes, in the distortion-removing step, deforming the engaging elements into shapes substantially the same as the cavity spaces.

The manufacturing method according to the present invention preferably includes using, as the synthetic resin, a synthetic resin that contains, as a main component, a thermoplastic saturated polyester resin containing terephthalic acid as an acid component and ethylene glycol as a glycol component.

In this case, the saturated polyester resin preferably contains a recycled polyethylene terephthalate resin.

The manufacturing method according to the present invention preferably includes, in the distortion-removing step, heating the engaging elements at “a glass transition temperature of the synthetic resin −20° C.” or higher and “the glass transition temperature of the synthetic resin +20° C.” or lower.

The manufacturing method according to the present invention preferably includes using, as the synthetic resin, a synthetic resin having a melt flow rate of 30 g/10 min or more and 100 g/10 min or less.

The manufacturing method according to the present invention preferably includes using, as the synthetic resin, a synthetic resin having a number-average molecular weight Mn of 10,000 or more and 30,000 or less and a molecular weight distribution Mw/Mn of 2.0 or more and 3.0 or less.

Next, a surface fastener provided by the present invention is a surface fastener made of a synthetic resin and including a base portion elongated in a machine direction and a plurality of engaging elements provided on the base portion, the engaging elements each having a stem portion protruding from the base portion and an engaging portion located at a leading end portion of the stem portion, characterized in that a main component of the synthetic resin is a thermoplastic saturated polyester resin containing terephthalic acid as an acid component and ethylene glycol as a glycol component, a maximum dimension of each of the engaging elements in a cross direction orthogonal to the machine direction is 0.2 mm or more and 1.0 mm or less, and the plurality of engaging elements are arranged at a density of 30 elements/cm² or more and 90 elements/cm² or less.

In the surface fastener according to the present invention, a melt flow rate of the synthetic resin is preferably 30 g/10 min or more and 100 g/10 min or less.

In the surface fastener according to the present invention, a number-average molecular weight Mn of the synthetic resin is preferably 10,000 or more and 30,000 or less, and a molecular weight distribution Mw/Mn of the synthetic resin is preferably 2.0 or more and 3.0 or less.

In the surface fastener according to the present invention, the saturated polyester resin preferably contains a recycled polyethylene terephthalate resin.

### Advantageous Effects of Invention

According to the surface fastener manufacturing method according to the present invention, it is possible to manufacture a surface fastener made of a synthetic resin containing a saturated polyester resin (in particular, a PET resin) as a main component and not including a factor that impedes recycling of the saturated polyester resin. Therefore, use of the surface fastener provided by the present invention can realize mono-materialization in which the whole of a product to which a surface fastener is attached, such as a clothing item, is formed by using a single synthetic resin, and consequently enables the saturated polyester resin to be efficiently recycled.

### BRIEF DESCRIPTION OF DRAWINGS

FIG. 1 is a schematic view schematically illustrating a manufacturing apparatus used in a surface fastener manufacturing method according to an embodiment of the present invention.

FIG. 2 is a schematic view schematically illustrating a wheel part of a die wheel in the manufacturing apparatus illustrated in FIG. 1.

FIG. 3 is a schematic side view of first engaging elements of a surface fastener according to an embodiment of the present invention, as viewed in a width direction (cross direction).

FIG. 4 is a schematic side view of second engaging elements of the surface fastener according to the embodiment of the present invention, as viewed in the width direction (cross direction).

FIG. 5 is a schematic front view of a relevant part of the surface fastener, as viewed in a length direction (machine direction MD).

FIG. 6 is a side view schematically illustrating a first engaging element immediately after being separated from the die wheel of the manufacturing apparatus illustrated in FIG. 1.

FIG. 7 is a side view schematically illustrating a second engaging element immediately after being separated from the die wheel of the manufacturing apparatus illustrated in FIG. 1.

### DESCRIPTION OF EMBODIMENTS

Hereinafter, a suitable embodiment of the present invention will be described in detail with reference to the drawings.

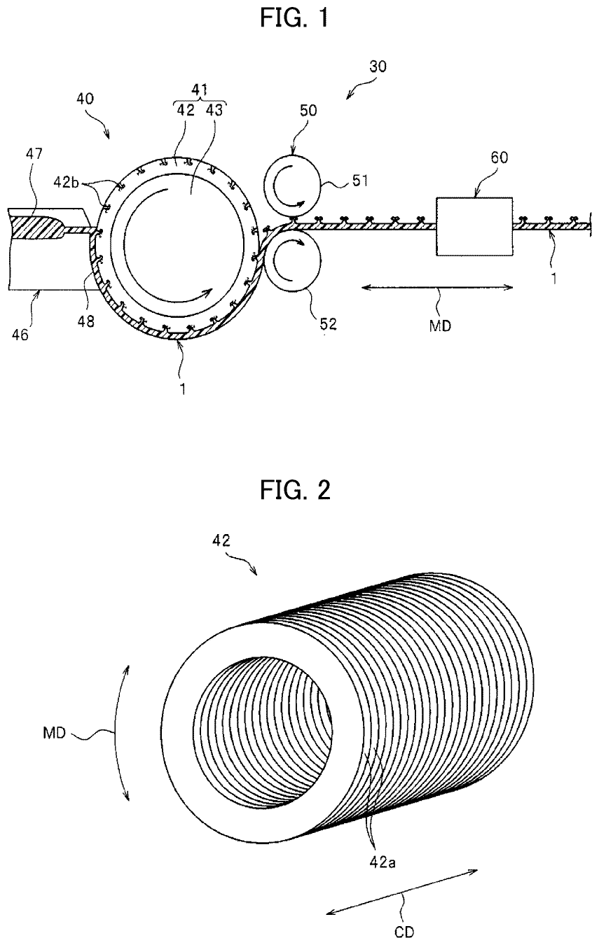

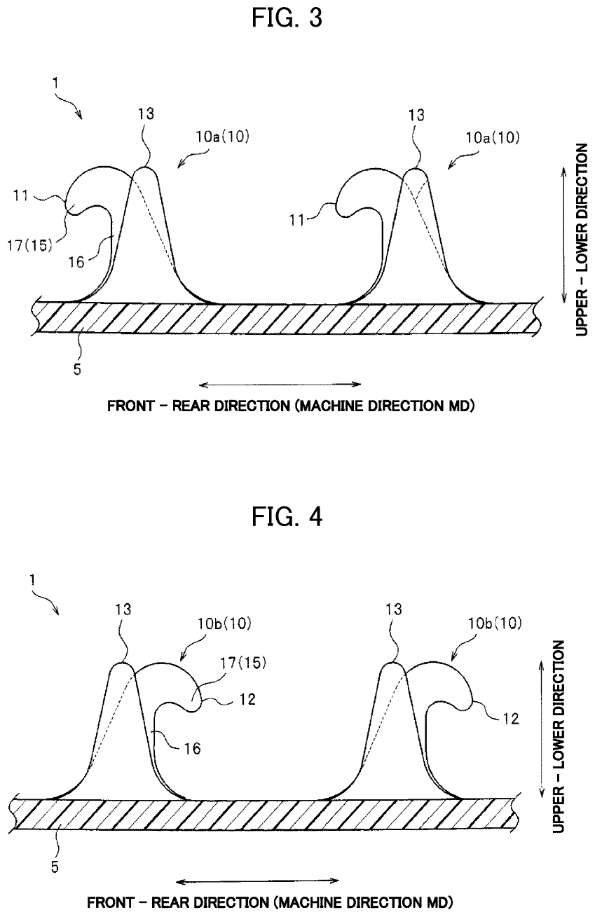

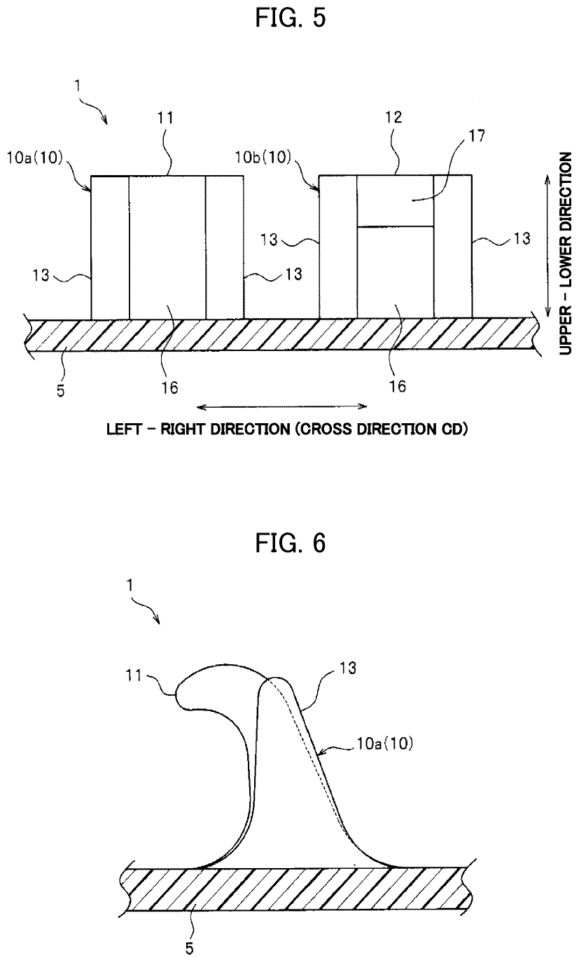

FIG. 1 is a schematic view schematically illustrating a manufacturing apparatus used in the present embodiment, and FIG. 2 is a schematic view schematically illustrating a wheel part of a die wheel. FIGS. 3 and 4 are side views of engaging elements of a surface fastener according to the present embodiment, and FIG. 5 is a front view of the engaging elements.

Note that, in the following description, the front-rear direction is a direction along a direction in which a surface fastener or a synthetic resin thereof is transported in a manufacturing step or manufacturing apparatus of the surface fastener, or a direction along the length direction of a surface fastener manufactured to have a long length. Furthermore, the front-rear direction is a machine direction MD. In this case, the downstream side in the transport direction described above is defined as the front side, and the upstream side in the transport direction is defined as the rear side.

The left-right direction is a direction along a cross direction CD orthogonal to the machine direction MD in the manufacturing step of the surface fastener or a width direction of the surface fastener, the width direction being orthogonal to the front-rear direction and along a flat or substantially flat upper surface (first surface) of a base portion. The upper-lower direction is a direction along a direction orthogonal to the flat or substantially flat upper surface of the base portion and is also referred to as a thickness direction or a height direction of the surface fastener. Furthermore, the upper-lower direction is a direction orthogonal to both the machine direction MD and the cross direction CD. In this case, the direction in which engaging elements protrude with respect to the base portion is defined as an upward direction, and the direction opposite to the upward direction is defined as a downward direction.

First, a surface fastener 1 manufactured by a manufacturing method according to the present embodiment will be described.

In the present embodiment, a manufacturing apparatus 30 illustrated in FIG. 1 is used to thereby manufacture a surface fastener 1 which is made of a synthetic resin and in which a plurality of engaging elements 10 are formed integrally on a flat-plate-shaped base portion 5, as illustrated in FIGS. 3 to 5. This surface fastener 1 is elongated in the machine direction MD in the manufacturing step. Note that, in the present invention, the length dimension (the dimension in the front-rear direction) and the width dimension (the dimension in the left-right direction) of the surface fastener 1 are not particularly limited, and the size of the surface fastener 1 can be changed by, for example, cutting the surface fastener 1.

The surface fastener 1 according to the present embodiment is formed of a synthetic resin containing, as a main component, a saturated polyester resin (specifically, a PET resin) having thermoplasticity and high crystallinity. In this case, the synthetic resin forming the surface fastener 1 contains a PET resin as a main component, and preferably, components that impede recycling of the PET resin (impeding materials), for example, elastomers, synthetic resins other than the PET resin, materials other than synthetic resins, and the like are not contained in this synthetic resin. Note that the above-described components that impede recycling may be contained in the synthetic resin of the surface fastener 1; however, in this case, the content of such a component that impedes recycling is required to be 1 wt % or less in consideration of recyclability.

In the present invention, the PET resin is a saturated polyester resin containing terephthalic acid as an acid component and ethylene glycol as a glycol component and has thermoplasticity. Herein, the main component of the synthetic resin refers to a component accounting for the highest ratio in the whole of the surface fastener 1. For example, in the present embodiment, the PET resin (main component) preferably accounts for 90 wt % or more, in particular, 95 wt % or more of the synthetic resin forming the surface fastener 1. In this case, the synthetic resin containing a PET resin as a main component does not contain components that impede recycling of the PET resin as described above, but may contain additives and auxiliary agents that do not impede recycling of the PET resin, such as a lubricant and a stabilizing auxiliary agent.

By manufacturing a surface fastener 1 using the above-mentioned synthetic resin that contains a PET resin as a main component (that is, a pure PET resin containing no components that impede recycling of the PET resin, such as elastomers), the manufactured surface fastener 1 can be suitably used in mono-material products (for example, clothing) formed of the PET resin. In addition, the PET resin can be efficiently recycled from mono-material products to which the surface fastener 1 is attached.

Furthermore, in the present embodiment, the PET resin forming the surface fastener 1 is formed only of a recycled PET resin recycled from products made of a PET resin, such as PET bottles (100% recycled PET resin). In this case, the recycled PET resin contains 0.5 mol % or more and 5.0 mol % or less of isophthalic acid. Isophthalic acid is a substance added to a PET resin for the purpose of, for example, enhancing transparency of products such as PET bottles and improving processability, and, in general, the recycled PET resin recycled from PET bottles or the like contains isophthalic acid in the above-mentioned proportion.

In the present embodiment, the surface fastener 1 is formed of a PET resin having a percentage of recycled PET resin of 100% as described above, and this achieves the effects of saving earth resources, reducing the waste disposal volume, reducing greenhouse gas emissions, etc.

In the present embodiment, the surface fastener 1 is formed of a synthetic resin (PET resin) having a melt flow rate (MFR) of 30 g/10 min or more and 100 g/10 min or less, a number-average molecular weight Mn of 10,000 or more and 30,000 or less, and a molecular weight distribution Mw/Mn of 2.0 or more and 3.0 or less.

When the MFR of the synthetic resin is 30 g/10 min or more, in molding the surface fastener 1, the synthetic resin (PET resin) is easily melted by heating, and flowability of the synthetic resin can be increased; therefore, the molten synthetic resin can be stably fed from a nozzle unit 46 of the manufacturing apparatus 30 toward a die wheel 41, which will be described later. When the MFR of the synthetic resin is 100 g/10 min or less, cavity spaces 42b of engaging elements 10 provided in the die wheel 41 can be easily filled with the molten synthetic resin. Furthermore, the strength of the molded engaging elements 10 can be easily ensured. Note that the melt flow rate (MFR) in the present invention is a value measured by the measurement method of MFR (method B) specified in JIS K7210.

When the number-average molecular weight Mn of the synthetic resin is 10,000 or more, the viscosity of the molten synthetic resin can be appropriately increased to improve extrusion stability. Moreover, in the surface fastener 1 to be manufactured, the strength of the engaging elements 10 can be easily ensured. When the number-average molecular weight Mn of the synthetic resin is 30,000 or less, flowability of the molten synthetic resin is appropriately ensured, and the cavity spaces 42b of the die wheel 41 can be easily filled with the molten synthetic resin.

When the molecular weight distribution Mw/Mn of the synthetic resin is 2.0 or more, the occurrence of the phenomenon in which the synthetic resin adheres at low temperatures can be reduced, and the synthetic resin can be easy melted for a short time; therefore, moldability of the synthetic resin can be enhanced. When the molecular weight distribution Mw/Mn of the synthetic resin is 3.0 or less, the strength of the engaging elements 10 can be easily ensured.

Note that, in the present invention, the PET resin includes a recycled PET resin recycled from PET bottles or the like and a virgin PET resin derived from petroleum. That is, the surface fastener 1 according to the present invention may be formed of, rather than a recycled PET resin, a virgin PET resin derived from petroleum or a mixture of a recycled PET resin and a virgin PET resin. Alternatively, in the present invention, the surface fastener 1 may be formed of, rather than a PET resin, a thermoplastic saturated polyester resin other than a PET resin.

The surface fastener 1 made of a PET resin (recycled PET resin) according to the present embodiment includes, as illustrated in FIGS. 3 to 5, a thin-plate-shaped base portion 5 that is elongated in the front-rear direction and a plurality of engaging elements 10 that protrude from an upper surface of the base portion 5. The base portion 5 has an upper surface (first surface) and a lower surface (second surface) disposed on the opposite side from the upper surface. The upper surface and the lower surface of the base portion 5 are each formed to be flat or substantially flat and are disposed to be parallel to each other.

The base portion 5 has a thickness dimension (dimension in the upper-lower direction) of 100 μm or more and 300 μm or less. When the thickness dimension of the base portion 5 is 100 μm or more, the base portion 5 can be stably molded in a molding step of the surface fastener 1 described later. In addition, the plurality of engaging elements 10 can be stably supported on the base portion 5. When the thickness dimension of the base portion 5 is 300 μm or less, the surface fastener 1 can have appropriate flexibility. Note that, in the present invention, the shape and the size of the base portion 5 are not particularly limited.

The plurality of engaging elements 10 are provided integrally with the base portion 5. The engaging elements 10 according to the present embodiment have first engaging elements 10a (refer to FIG. 3) in which leading end portions of the engaging elements 10 are directed to the upstream side (rear side) of the machine direction MD and second engaging elements 10b (refer to FIG. 4) in which leading end portions of the engaging elements 10 are directed to the downstream side (front side) of the machine direction MD.

In the surface fastener 1, a plurality of first engaging elements 10a are arranged at regular intervals in the front-rear direction and thereby form a first element row parallel to the front-rear direction. In addition, a plurality of second engaging elements 10b are arranged at regular intervals in the front-rear direction and thereby form a second element row parallel to the front-rear direction. In the surface fastener 1 according to the present embodiment, a plurality of first element rows and a plurality of second element rows are provided. The first element rows and the second element rows are alternately arranged in the width direction of the surface fastener 1. Note that, in the present invention, the arrangement of the engaging elements 10 (the first engaging elements 10a and the second engaging elements 10b) is not particularly limited and can be changed depending on, for example, the form of products in which the surface fastener 1 is used.

Each of the engaging elements 10 (each of the first engaging elements 10a and second engaging elements 10b) at least has an undercut portion (undercut shape) 15 where the engaging element 10 cannot be pulled out from a cavity space 42b described later in its original shape when the engaging element 10 is pulled out from the cavity space 42b of the die wheel 41 in the manufacturing of the surface fastener 1.

Each of the first engaging elements 10a has a first main portion 11 protruding from the base portion 5 in an inverted J-shape so that a leading end portion is directed to the upstream side of the machine direction MD and a pair of left and right ribs 13, and, for example, as illustrated in FIG. 5, the first main portion 11 and the ribs 13 are formed integrally in a form in which the first main portion 11 is sandwiched between the left and right ribs 13. Each of the second engaging elements 10a has a second main portion 12 protruding from the base portion 5 in an inverted J-shape so that a leading end portion is directed to the downstream side of the machine direction MD and a pair of left and right ribs 13, and, for example, as illustrated in FIG. 5, the second main portion 12 and the ribs 13 are formed integrally in a form in which the second main portion 12 is sandwiched between the left and right ribs 13. Note that, in the present invention, the engaging elements may be formed without providing ribs.

The first main portion 11 of the first engaging element 10a and the second main portion 12 of the second engaging element 10b have shapes symmetrical to each other in the front-rear direction, for example, in side view (FIGS. 3 and 4) as each of the engaging elements 10 is viewed in the left-right direction. In addition, the first main portion 11 and the second main portion 12 each have a stem portion 16 protruding upward from the base portion 5 and an engaging portion (engaging head portion) 17 extending from a leading end portion (upper end portion) of the stem portion 16 toward one side of the machine direction MD.

The stem portion 16 according to the present embodiment has a shape in which the length dimension (dimension in the front-rear direction) of the stem portion 16 gradually decreases toward a direction away from the base portion 5. The engaging portion 17 is formed so as to protrude from a position of an upper end portion including the upper end of the stem portion 16 toward one side of the front-rear direction (forward or rearward) and to bend in a direction toward the base portion 5. Note that, in the present embodiment, the direction away from the base portion 5 and the direction toward the base portion 5 are the upward direction and the downward direction, respectively, in the upper-lower direction.

In side view (FIGS. 3 and 4) of each of the engaging elements 10, the engaging portion 17 has a shape that tapers toward the leading end of the engaging portion 17. The lower surface of the engaging portion 17 has a curved surface curved to be concave upward. With this shape of the engaging portion 17, a loop of a loop member can be hooked on the engaging element 10. Furthermore, in the engaging elements 10 according to the present embodiment, the engaging portion 17 of the first main portion 11 and the engaging portion 17 of the second main portion 12 are formed as the undercut portions 15 described above.

The left and right ribs 13 provided for each of the engaging elements 10 have shapes symmetrical to each other in the left-right direction. Each of the ribs 13 is formed in a shape that is symmetrical in the front-rear direction with respect to the center position in the front-rear direction in side view (FIGS. 3 and 4) of the engaging elements 10. In addition, each rib 13 has a shape in which the length dimension of the rib 13 gradually decreases toward a direction away from the base portion 5.

As illustrated in FIG. 5, the first main portion 11 and the left and right ribs 13 of the first engaging element 10a are formed so that the maximum height dimensions are equal to each other. The second main portion 12 and the left and right ribs 13 of the second engaging element 10b are formed so that the maximum height dimensions are equal to each other. Furthermore, the first engaging element 10a and the second engaging element 10b are formed so that the maximum height dimensions are equal to each other.

The width dimension in each of the first main portion 11 and the second main portion 12 is as large as 0.2 mm or more, preferably 0.4 mm or more. This enables, in manufacturing a surface fastener 1 using the manufacturing apparatus 30 illustrated in FIG. 1, the cavity spaces 42b of the engaging elements 10 provided in the die wheel 41 to be easily filled with a synthetic resin (recycled PET resin) forming the surface fastener 1 in a molten state, and enables the shapes of the engaging portions 17 to be formed exactly according to the cavity spaces 42b. In addition, for the engaging elements 10, since the left and right ribs 13 are provided on the outside of the first main portion 11 and the second main portion 12 in the left-right direction, the cavity spaces 42b can be more easily filled with the synthetic resin. The overall width dimension of each of the engaging elements 10 including the left and right ribs 13 can be 0.4 mm more, preferably 0.6 mm or more. Note that the ribs 13 may be formed at a height lower than the heights of the first main portion 11 and the second main portion 12. The shapes of the ribs 13 are also not particularly limited, but the left and right ribs 13 are preferably formed adjacent to the first main portion 11 or the second main portion 12 and integrally with the first main portion 11 or the second main portion 12.

Furthermore, the engaging elements 10 according to the present embodiment are formed so that the overall width dimension of each of the engaging elements 10 is 1.0 mm or less, preferably 0.8 mm or less. In this case, when the surface fastener 1 manufactured in the present embodiment is engaged with a loop member, loops of the loop member can be easily hooked on the respective engaging elements 10 of the surface fastener 1, and thus the surface fastener 1 can be stably engaged with the loop member.

In the present embodiment, the maximum value of the height dimension (dimension in the upper-lower direction) of each of the engaging elements 10 from the base portion 5 is 0.45 mm or more and 1.40 mm or less, and the maximum value of the length dimension (dimension in the front-rear direction) of the engaging element 10 is 0.30 mm or more and 1.67 mm or less. Due to the maximum height dimension of the engaging element 10 being 0.45 mm or more and/or the maximum length dimension being 0.30 mm or more, a loop of the loop member can be easily hooked on the engaging element 10. Due to the maximum height dimension of the engaging element 10 being 1.40 mm or less and/or the maximum length dimension being 1.67 mm or less, the surface fastener 1 can have appropriate softness and pleasant texture.

In the present embodiment, the plurality of engaging elements 10 are regularly arranged in a grid arrangement pattern in which the engaging elements 10 are arrayed in the front-rear direction and in the left-right direction. In this case, the plurality of engaging elements 10 are arranged on the base portion 5 in such a manner that a formation density of the engaging elements 10 is significantly smaller than that of, for example, the surface fastener disclosed in PTL 1. Specifically, the plurality of engaging elements 10 are arranged at a density of 30 elements/cm² or more and 90 elements/cm² or less.

Due to the formation density of the engaging elements 10 being 30 elements/cm² or more, when the surface fastener 1 according to the present embodiment is engaged with a loop member, the engaging strength of the surface fastener 1 with respect to the loop member can be appropriately ensured. Specifically, for example, in a case of using the surface fastener 1 in products such as clothing, an engaging strength generally required for the surface fastener 1 can be stably obtained.

Due to the formation density of the engaging elements 10 being 90 elements/cm² or less, the number of engaging elements 10 having the undercut portion 15 per unit area can be reduced, and thus, in a separating step described later, a molded surface fastener 1 can be easily separated from the die wheel 41. In addition, flexibility of the surface fastener 1 to be manufactured can be improved.

Note that, in the present invention, the arrangement pattern of the engaging elements is not limited to the grid arrangement pattern in which the engaging elements are regularly arrayed in the front-rear direction and in the left-right direction as described above, and, for example, a plurality of engaging elements may be regularly arranged on the base portion in another arrangement pattern such as a staggered arrangement pattern or may be randomly arranged on the base portion depending on, for example, the form or properties of products in which the surface fastener is used.

Next, the manufacturing apparatus 30 with which the above-described surface fastener 1 according to the present embodiment is manufactured will be described with reference to FIG. 1.

The manufacturing apparatus 30 according to the present embodiment includes a molding device 40 that molds the surface fastener 1, a pickup roller 50 that separates the surface fastener 1 from the molding device 40, and a heating device 60 disposed on the downstream side of the pickup roller 50.

The molding device 40 according to the present embodiment includes a die wheel 41 that is driven to rotate in one direction and a nozzle unit 46 that is disposed to face the outer peripheral surface of the die wheel 41. The die wheel 41 includes a wheel part 42 that serves as a mold member and a rotation drive roller 43 that rotates the wheel part 42 at a predetermined speed in one direction. The rotation drive roller 43 can rotate a plurality of ring plates 42a that form the wheel part 42 concentrically at the same time and at the same rotational speed.

As illustrated in FIG. 2, the wheel part 42 is composed of a plurality of doughnut-shaped ring plates (mold plates) 42a each of which has a predetermined thickness and which are stacked on top of each other in the cross direction CD or the direction of the rotation axis of the die wheel 41, whereby the wheel part 42 has a circular columnar shape with a hollow central part.

A plurality of cavity spaces 42b (not illustrated in FIG. 2) with which the above-described engaging elements 10 of the surface fastener 1 can be molded are provided in outer peripheral edge portions of the wheel part 42 at regular intervals in the circumferential direction of the ring plates 42a. In this case, the cavity spaces 42b of the engaging elements 10 are provided in the outer peripheral edge portions of the wheel part 42 in accordance with the arrangement pattern of the engaging elements 10 in the surface fastener 1 to be manufactured.

For example, in the case of the present embodiment, one ring plate 42a has a plurality of cavity spaces 42b with which any one portion of the first main portion 11 of the first engaging element 10a, the second main portion 12 of the second engaging element 10b, and the rib 13 of the first engaging element 10a or the second engaging element 10b can be molded. Furthermore, the wheel part 42 also includes ring plates 42a for spacers used for forming space parts (regions where engaging elements 10 are not formed) between engaging elements 10 that are adjacent to each other in the width direction. The ring plates 42a for spacers are not provided with cavity spaces 42b.

In this case, the cavity spaces 42b in each ring plate 42a are each provided in an outer peripheral edge portion of the ring plate 42a by a conventionally known technique such as wire-cut electric discharge machining, laser machining, or etching. In addition, a cavity space 42b with which one engaging element 10 can be molded is formed by using three types of ring plates 42a having cavity spaces of one rib 13 (on the left side), the first main portion 11 or the second main portion 12, and the other rib 13 (on the right side), and these three types of ring plates 42a are aligned with each other in the circumferential direction of the ring plates 42a and stacked in the cross direction CD. By adjusting the number of ring plates 42a used, the width dimensions of the ribs 13, the first main portion 11, and the second main portion 12 can be changed as appropriate.

In the die wheel 41 according to the present embodiment, a cavity space 42b provided in the wheel part 42 in order to mold one engaging element 10 (that is, a cavity space 42b formed by stacking three types of ring plates 42a) has a shape substantially the same as the engaging element 10 of the surface fastener 1 manufactured in the present embodiment. Therefore, the cavity space 42b of the engaging element 10 provided in the die wheel 41 includes a space in which the above-described undercut portion 15 of the engaging element 10 is molded.

Herein, the term substantially the same shape refers to two shapes being the same shape as each other and two shapes being approximately the same shape. The expression that the cavity space 42b of the die wheel 41 and the engaging element 10 have the same shape means that, for example, when the shape of the cavity space 42b as viewed in the cross direction CD and the shape of the engaging element 10 as viewed in the width direction are superposed with each other, the two shapes completely overlap. The expression that the cavity space 42b of the die wheel 41 and the engaging element 10 have approximately the same shape means that, for example, when the shape of the cavity space 42b as viewed in the cross direction CD and the shape of the engaging element 10 as viewed in the width direction are superposed with each other, the two shapes overlap in a range (area) of 80% or more, preferably in a range (area) of 90% or more.

The die wheel 41 according to the present embodiment includes a cooling jacket (not illustrated) in which a cooling liquid is circulated in the rotation drive roller 43 in order to efficiently cool the surface fastener 1 molded along the outer peripheral surface of the die wheel 41. In addition, a cooling liquid tank, which is not illustrated, is provided below the die wheel 41 so that at least a portion of the die wheel 41 is immersed in the cooling liquid in the cooling liquid tank.

The nozzle unit 46 is configured to continuously feed a molten synthetic resin toward the die wheel 41. Specifically, the nozzle unit 46 includes a flow path 47 that allows a synthetic resin in a molten state to flow through, a nozzle end face 48 that is disposed to face the die wheel 41, and a feed port that opens at the nozzle end face 48 and is capable of continuously extruding (or discharging) the molten synthetic resin from the feed port toward the die wheel 41.

The pickup roller 50 includes a pair of an upper nipping roller 51 and a lower nipping roller 52 that nip the surface fastener 1 molded on the die wheel 41 from above and below and pull the surface fastener 1. The upper nipping roller 51 and the lower nipping roller 52 each have, on the outer peripheral surface thereof, a surface layer that is not illustrated but is formed of an elastomer such as a polyurethane elastomer.

The heating device 60 is disposed on the downstream side with respect to the pickup roller 50 in the machine direction MD. The heating device 60 is configured to heat the surface fastener 1 that is separated from the die wheel 41 and transported to the downstream side at a preset heating temperature for a preset heating time.

Note that, in the present invention, the specific structure, shape, size, heating means, and the like of the heating device are not particularly limited. The heating device 60 according to the present embodiment is configured to heat the surface fastener 1 separated from the die wheel 41 while transporting the surface fastener 1; alternatively, the heating device according to the present invention may be configured such that, for example, the surface fastener 1 separated from the die wheel 41 is wound around, for example, a collection roller (not illustrated), and the collection roller is then held in the heating device to heat the surface fastener 1 together with the collection roller in a state where the surface fastener 1 is wound around the collection roller.

Next, a description will be given of a manufacturing method for manufacturing the surface fastener 1 made of a synthetic resin that contains a PET resin as a main component using the above-described manufacturing apparatus 30 including the molding device 40, the pickup roller 50, and the heating device 60.

In the present invention, in order to improve recyclability of products formed of synthetic resins, it has been attempted to use, as the material of the surface fastener 1, a synthetic resin containing a saturated polyester resin (in particular, a recycled PET resin) as a main component, various experiments using the above-described molding device including the die wheel to manufacture a surface fastener have been repeatedly conducted, and as a result, it has been revealed that the following problems occur in manufacturing a surface fastener using a PET resin (in particular, a PET resin containing a recycled PET resin).

Specifically, it has been found that in the case of molding using a PET resin containing a recycled PET resin, the PET resin exhibits, for example, the following properties: the temperature range in which the PET resin can be melted and processed is extremely narrow; when the PET resin is cooled from a molten state, flowability of the PET resin decreases rapidly; and the cooled PET resin hardens easily. Moreover, since the PET resin has such properties, in the case of manufacturing a surface fastener by feeding a PET resin containing a recycled PET resin into a die wheel, due to a combination of various factors, it is extremely difficult for engaging elements to be molded into an appropriate shape that can engage with a loop member, which is a problem specific to the material, and it has been revealed that the PET resin containing a recycled PET resin is a material that is difficult to process as a material of the surface fastener 1.

In view of the above, the inventors of the present invention have repeatedly conducted further experiments and studies in order to manufacture a surface fastener from a PET resin containing a recycled PET resin, and consequently, it has been found that, by deforming a molded body (engaging element) made of a PET resin, distortion is generated in the molded body, and the distortion of the molded body can be removed by subsequently heating the molded body in a particular temperature range, and that the removal of the distortion of the molded body by heating enables the molded body to be deformed into its original shape before the distortion is generated, and this finding has led to the completion of the present invention.

Specifically, a method for manufacturing a surface fastener 1 according to the present embodiment at least includes a molding step of molding a surface fastener 1 with the die wheel 41 of the molding device 40 described above, a separating step of separating the surface fastener 1 from the die wheel 41 using the pickup roller 50 to generate distortion in engaging elements 10, and a distortion-removing step of deforming the engaging elements 10 to their original shapes by heating at least the engaging elements 10 of the separated surface fastener 1 to remove the distortion of the engaging elements 10.

In the molding step, first, in the manufacturing apparatus 30 illustrated in FIG. 1, a molten synthetic resin (PET resin) is continuously fed from the nozzle unit 46 toward the outer peripheral surface of the die wheel 41. At this time, the PET resin is fed from the nozzle unit 46 while being heated to a melting point of the PET resin or higher and a temperature of “melting point of synthetic resin +60° C.” or lower. Furthermore, the die wheel 41 is rotated by the rotation drive roller 43 in the counterclockwise direction in FIG. 1 at a constant rotational speed.

This enables the base portion 5 to be continuously molded between the outer peripheral surface of the rotating die wheel 41 and the nozzle end face 48 of the nozzle unit 46. In addition, since the cavity spaces 42b provided in outer peripheral edge portions of the die wheel 41 are filled with the molten PET resin, engaging elements 10 (first engaging elements 10a and second engaging elements 10b) can be molded in the cavity spaces 42b. Thus, a surface fastener 1 in which a plurality of engaging elements 10 are provided integrally on the base portion 5 as illustrated in FIGS. 3 to 5 is molded in and near the outer peripheral edge portions of the die wheel 41.

In the molding step according to the present embodiment, by heating the PET resin fed from the nozzle unit 46 to a temperature of “melting point of synthetic resin +60° C.” or lower as described above, the PET resin can be prevented from decomposing. In addition, an excessively increase in flowability of the molten PET resin can be suppressed, and the cavity spaces 42b of the die wheel 41 can be stably filled with the PET resin.

Furthermore, in the present embodiment, a synthetic resin containing a PET resin (recycled PET resin) as a main component and having an MFR of 30 g/10 min or more and 100 g/10 min or less is used as the synthetic resin fed into the die wheel 41 as described above. Furthermore, in the present embodiment, a synthetic resin having a number-average molecular weight Mn of 10,000 or more and 30,000 or less and a molecular weight distribution Mw/Mn of 2.0 or more and 3.0 or less is used. Thus, the molten PET resin (recycled PET resin) can be stably fed from the nozzle unit 46 to the die wheel 41. In addition, the cavity spaces 42b of the engaging elements 10 provided in the die wheel 41 can be more stably filled with the molten synthetic resin. Accordingly, in the outer peripheral edge portions of the die wheel 41, a plurality of engaging elements 10 can be stably molded into shapes that are the same (or shapes that are substantially the same) as the cavity spaces 42b provided in the die wheel 41.

Furthermore, in the present embodiment, the maximum value of the width dimension (dimension in the cross direction CD) of each of the cavity spaces 42b of the engaging elements 10 provided in the die wheel 41 is set to 0.4 mm or more, preferably 0.6 mm or more in accordance with the overall width dimension of each of the engaging elements 10 to be molded. This enables the molten synthetic resin to be caused to flow more stably into the cavity spaces 42b of the die wheel 41 to fill the cavity spaces 42b.

In this molding step, the surface fastener 1 molded with the die wheel 41 rotates together with the die wheel 41 toward the pickup roller 50 while being held by the die wheel 41. At this time, the surface fastener 1 is cooled by a cooling liquid circulating in the rotation drive roller 43 of the die wheel 41 and cooled by being immersed in a cooling liquid in the cooling liquid tank (not illustrated); therefore, the surface fastener 1 can be hardened (solidified) for a short time before being rotated into the position of the pickup roller 50.

Next, the separating step of separating the surface fastener 1 molded in the above-described molding step from the die wheel 41 is performed.

In this separating step, the surface fastener 1 is nipped and held by the upper nipping roller 51 and the lower nipping roller 52 of the pickup roller 50 in the upper-lower direction, and the upper nipping roller 51 and the lower nipping roller 52 each rotate, whereby the surface fastener 1 can be pulled by the upper nipping roller 51 and the lower nipping roller 52 with strong force. Thus, the engaging elements 10 of the surface fastener 1 can be pulled out from the cavity spaces 42b provided in the outer peripheral edge portions of the die wheel 41, and the base portion 5 of the surface fastener 1 can be peeled off from the outer peripheral surface of the die wheel 41, whereby the surface fastener 1 can be separated from the die wheel 41.

At this time, the engaging elements 10 molded in the cavity spaces 42b of the die wheel 41 each have a first main portion 11 and left and right ribs 13 or a second main portion 12 and left and right ribs 13, as described above. Furthermore, when the surface fastener 1 is separated from the die wheel 41, the engaging elements 10 are each pulled out from the cavity spaces 42b of the continuously rotating die wheel 41, while the base portion 5 of the surface fastener 1 is bent so as to curve.

In this case, in the engaging elements 10, the engaging portion 17 of each of the first main portions 11 and the second main portions 12 protrudes from the stem portion 16 in the direction in which the die wheel 41 rotates, and thus becomes an undercut portion 15 that cannot be pulled out from the cavity space 42b in its original shape. Furthermore, the left and right ribs 13 of the first engaging elements 10a and the second engaging elements 10b also have shapes that are difficult to pull out from the cavity spaces 42b of the rotating die wheel 41 in their original shape.

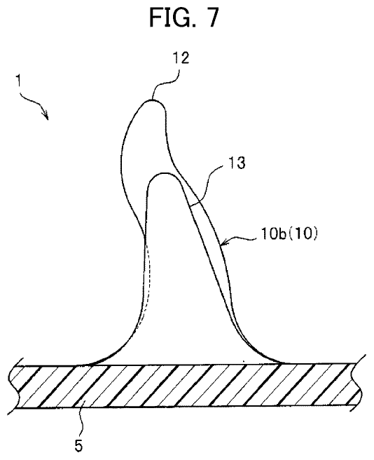

Therefore, by strongly pulling the molded surface fastener 1 using the pickup roller 50, the engaging elements 10 of the surface fastener 1 are forcibly pulled out from the cavity spaces 42b of the die wheel 41, and thus the surface fastener 1 can be separated from the die wheel 41. In addition, the surface fastener 1 is separated, and at the same time, the engaging elements 10 are thereby deformed from the shapes illustrated in FIGS. 3 and 4 to the shapes illustrated in FIGS. 6 and 7, respectively, so that distortion can be generated in the engaging elements 10. At this time, in the engaging elements 10 having the shapes illustrated in FIGS. 6 and 7, distortion is generated in areas that deform from the shapes illustrated in FIGS. 3 and 4, respectively.

More specifically, for example, in the case of the second engaging element 10b, the second engaging element 10b in a cavity space 42b having the shape illustrated in FIG. 4 is forcibly pulled by the pickup roller 50 and pulled out from the cavity space 42b, whereby the stem portion 16 and the engaging portion 17 of the second main portion 12 significantly deform so that the engaging portion 17 of the second main portion 12 is directed upward, as illustrated in FIG. 7. In addition, the left and right ribs 13 of the second engaging element 10b deform so that the upper end portions of the ribs 13 are inclined to the upstream side in the machine direction MD.

The first engaging element 10a in a cavity space 42b having the shape illustrated in FIG. 3 is pulled out from the cavity space 42b by the pickup roller 50, whereby the first main portion 11 deforms so that the engaging portion 17 of the first main portion 11 is displaced upward, and the left and right ribs 13 of the first engaging element 10a deform so that the upper end portions of the ribs 13 are inclined to the upstream side in the machine direction MD, as illustrated in FIG. 6.

Furthermore, in the surface fastener 1 according to the present embodiment, the plurality of engaging elements 10 are provided on the base portion 5 at a low density of 90 elements/cm² or less as described above. This prevents problems such as the surface fastener 1 getting caught on the die wheel 41 and becoming unable to be removed when the engaging elements 10 are deformed and pulled out from the cavity spaces 42b in the separating step and enables the surface fastener 1 to be stably separated from the die wheel 41.

Subsequently, the surface fastener 1 separated from the die wheel 41 by the pickup roller 50 is transported toward the heating device 60. Furthermore, in the heating device 60 in which the surface fastener 1 has been introduced, the distortion-removing step of removing distortion of the engaging elements 10 by heating the surface fastener 1 is performed.

In this distortion-removing step, the surface fastener 1 is heated by the heating device 60 in a temperature range of a glass transition temperature of the synthetic resin (recycled PET resin) forming the surface fastener 1 ±20° C. By subjecting the surface fastener 1 to heat treatment at this heating temperature, distortion generated in the engaging elements 10 in the above-described separating step is removed, and the engaging elements 10 of the surface fastener 1 can be deformed from the distorted shapes illustrated in FIGS. 6 and 7 to the shapes that are substantially the same as the cavity spaces 42b of the die wheel 41 as illustrated in FIGS. 3 and 4, respectively.

At this time, when the heating temperature of the surface fastener 1 in the distortion-removing step is a temperature of “glass transition temperature of synthetic resin −20° C.” or higher, distortion generated in the engaging elements 10 can be stably removed. When the heating temperature of the surface fastener 1 is a temperature of “glass transition temperature of synthetic resin +20° C.” or lower, the progress of crystallization of the synthetic resin can be suppressed, and the surface fastener 1 to be manufactured can have appropriate softness and flexibility.

The heat treatment of the surface fastener 1 with the heating device 60 is preferably performed for 10 minutes or more. A heating time of 10 minutes or more can stably remove the distortion generated in the engaging elements 10. On the other hand, performing the heat treatment of the surface fastener 1 for 60 minutes is enough to remove the distortion of the engaging elements 10. Accordingly, considering the productivity, the burden on manufacturing costs, etc. of the surface fastener 1, the heating time of the surface fastener 1 is preferably 60 minutes or less, in particular, 45 minutes or less.

Through this distortion-removing step, the surface fastener 1 according to the present embodiment having the plurality of engaging elements 10 illustrated in FIGS. 3 to 5 is manufactured.

Note that, in the distortion-removing step according to the present embodiment, heating of the surface fastener 1 is performed while transporting the surface fastener 1. However, in the present invention, the distortion generated in the engaging elements 10 can also be removed by, for example, winding the surface fastener 1 separated from the die wheel 41 around, for example, a collection roller (not illustrated) and then holding the collection roller in the heating device to heat the surface fastener 1 together with the collection roller in a state where the surface fastener 1 is wound around the collection roller, as described above. By performing the heat treatment with the surface fastener 1 being wound around a collection roller in this manner, a larger number of surface fasteners 1 can be heated for a short heating time, and thus the distortion-removing step can be efficiently performed.

Subsequently, the surface fastener 1 that has been subjected to the distortion-removing step is discharged from the heating device 60 and is collected by, for example, being wound into a roll on a collection roller or the like. Alternatively, the surface fastener 1 may be collected after being transported from the heating device 60 toward a cutting unit, which is not illustrated, and being cut in the cutting unit to a predetermined width dimension and/or length dimension. Note that the method for manufacturing a surface fastener 1 according to the present embodiment may further include, besides the molding step, the separating step, and the distortion-removing step described above, another step of subjecting the surface fastener 1 to processing or treatment, for example, a stretching step of stretching the surface fastener 1 in the machine direction MD.

The surface fastener 1 according to the present embodiment manufactured by the manufacturing method described above is formed of a PET resin (recycled PET resin) not including a factor that impedes recycling, such as an elastomer, and thus can be recycled as in PET bottles or the like and reused as a recycled PET resin.

Accordingly, the surface fastener 1 according to the present embodiment is suitably used in products such as clothing formed of a single PET resin (mono-material products). Furthermore, use of the surface fastener 1 according to the present embodiment can realize mono-materialization in which the whole of a product to which a surface fastener is attached, such as a clothing item, is formed by using a single PET resin. As a result, the efficiency of recycling of the PET resin can be improved. Furthermore, effects of saving earth resources, reducing the waste disposal volume, reducing greenhouse gas emissions, etc. can also be expected, thereby contributing to the sustainable development goals (SDGs).

Furthermore, in the surface fastener 1 according to the present embodiment, a plurality of engaging elements 10 are formed in shapes that can engage with loops of a loop member and are formed of a PET resin containing no elastomers, and thus are formed to be harder than, for example, typical conventional surface fasteners. Accordingly, even when the formation density of the engaging elements 10 in the surface fastener 1 is significantly reduced to 90 elements/cm² or less as described above, compared to typical conventional surface fasteners, the surface fastener 1 can be stably engaged with a loop member.

Moreover, in the surface fastener 1 according to the present embodiment, the engaging elements 10 are each formed to have a width dimension larger than those of typical conventional surface fasteners, and a PET resin (recycled PET resin) having an MFR, a number-average molecular weight Mn, and a molecular weight distribution Mw/Mn that are controlled to predetermined ranges is used as the synthetic resin forming the surface fastener 1. This enables the cavity spaces 42b of the die wheel 41 to be stably filled with the molten synthetic resin when the engaging elements 10 are molded with the die wheel 41 of the molding device 40 and thus enables the engaging elements 10 having predetermined shapes to be stably molded.

It should be noted that the present invention is not limited to the embodiment described above and that various modifications can be made as long as such modifications have a configuration substantially the same as that of the present invention and exhibit similar operational effects.

For example, in the surface fastener 1 according to the present embodiment described above, the engaging elements 10 each have a first main portion 11 or second main portion 12 formed in an inverted J-shape and left and right ribs 13. However, the shape of the engaging element according to the present invention is not particularly limited as long as the engaging element has a shape in which distortion can be generated in at least a portion of the engaging element (that is, a shape having an undercut portion that cannot be pulled out from a cavity space of the die wheel in its original shape) in the separating step of separating the surface fastener from the die wheel.

For example, in the present invention, each of the engaging elements of the surface fastener may have, for example, a shape in which the first main portion 11 and the second main portion 12 that are formed in an inverted J-shape according to the above-described embodiment and the left and right ribs 13 disposed on the outside of these main portions in the left-right direction are integrally formed. Alternatively, each of the engaging elements may be formed in a palm tree-like shape or a mushroom-like shape that is commonly known in the related art.

Moreover, in the embodiment described above, the surface fastener 1 is provided with a plurality of first engaging element 10a and a plurality of second engaging element 10b having shapes symmetrical to each other. However, in the present invention, one surface fastener may be provided with only one type of engaging element having the same shape or may be provided with three or more types of engaging elements having shapes that are different from each other.

In the manufacturing method according to the embodiment described above, the molding device 40 including the die wheel 41 configured to rotate and the nozzle unit 46 that is disposed to face the die wheel 41 is used to mold the surface fastener 1. However, in the present invention, the apparatus and the method for molding a surface fastener are not particularly limited as long as the surface fastener can be molded by feeding a molten synthetic resin into a mold having cavity spaces.

For example, in the present invention, the surface fastener 1 may be molded by using, instead of the molding device 40 according to the embodiment, a twin-roll molding device including a die wheel having a plurality of cavity spaces in an outer peripheral portion thereof, and a pressing wheel that is disposed to face the die wheel and that rotates in a direction opposite to the direction in which the die wheel rotates. In a case where such a twin-roll molding device is used, by feeding a molten synthetic resin between the die wheel and the pressing wheel, the base portion can be molded between the die wheel and the pressing wheel, and a plurality of engaging elements can be molded in the cavity spaces of the die wheel. Thus, a surface fastener similar to the surface fastener 1 according to the above-described embodiment can be molded. Furthermore, after molding of a surface fastener, when the surface fastener is separated from the die wheel of the twin-roll molding device, the engaging elements can be deformed to generate distortion in the engaging elements.

### Reference Signs List

1 surface fastener
5 base portion
10 engaging element
10a first engaging element
10b second engaging element
11 first main portion
12 second main portion
13 rib
15 undercut portion (undercut shape)
16 stem portion
17 engaging portion (engaging head portion)
30 manufacturing apparatus
40 molding device
41 die wheel
42 wheel part
42a ring plate (mold plate)
42b cavity space
43 rotation drive roller
46 nozzle unit
47 flow path
48 nozzle end face
50 pickup roller
51 upper nipping roller
52 lower nipping roller
60 heating device
CD cross direction
MD machine direction

1. A surface fastener manufacturing method in which a surface fastener made of a synthetic resin is manufactured, the surface fastener including a base portion and a plurality of engaging elements provided on the base portion, the engaging elements each having a stem portion protruding from the base portion and an engaging portion located at a leading end portion of the stem portion the surface fastener manufacturing method comprising:
a molding step of molding the surface fastener by feeding the molten synthetic resin into a mold in which cavity spaces are provided;
a separating step of separating the engaging elements from the cavity spaces and
a distortion-removing step of deforming the engaging elements by heating the separated engaging elements to remove distortion generated in the engaging elements after the separating step.

2. The surface fastener manufacturing method according to claim 1, comprising:
in the distortion-removing step, deforming the engaging elements into shapes substantially the same as the cavity spaces.

3. The surface fastener manufacturing method according to claim 1, comprising:
using, as the synthetic resin, a synthetic resin that contains, as a main component, a thermoplastic saturated polyester resin containing terephthalic acid as an acid component and ethylene glycol as a glycol component.

4. The surface fastener manufacturing method according to claim 3, wherein
the saturated polyester resin contains a recycled polyethylene terephthalate resin.

5. The surface fastener manufacturing method according to claim 1, comprising:
in the distortion-removing step, heating the engaging elements at “a glass transition temperature of the synthetic resin −20° C.” or higher and “the glass transition temperature of the synthetic resin +20° C.” or lower.

6. The surface fastener manufacturing method according to claim 1, comprising:
using, as the synthetic resin, a synthetic resin having a melt flow rate of 30 g/10 min or more and 100 g/10 min or less.

7. The surface fastener manufacturing method according to claim 1, comprising:
using, as the synthetic resin, a synthetic resin having a number-average molecular weight Mn of 10,000 or more and 30,000 or less and a molecular weight distribution Mw/Mn of 2.0 or more and 3.0 or less.

8. A surface fastener made of a synthetic resin and including a base portion elongated in a machine direction and a plurality of engaging elements provided on the base portion, the engaging elements each having a stem portion protruding from the base portion and an engaging portion located at a leading end portion of the stem portion, wherein
a main component of the synthetic resin is a thermoplastic saturated polyester resin containing terephthalic acid as an acid component and ethylene glycol as a glycol component,
a maximum dimension of each of the engaging elements in a cross direction orthogonal to the machine direction is 0.2 mm or more and 1.0 mm or less, and
the plurality of engaging elements are arranged at a density of 30 elements/cm² or more and 90 elements/cm² or less.

9. The surface fastener according to claim 8, wherein
a melt flow rate of the synthetic resin is 30 g/10 min or more and 100 g/10 min or less.

10. The surface fastener according to claim 8, wherein
a number-average molecular weight Mn of the synthetic resin is 10,000 or more and 30,000 or less, and
a molecular weight distribution Mw/Mn of the synthetic resin is 2.0 or more and 3.0 or less.

11. The surface fastener according to claim 8, wherein
the saturated polyester resin contains a recycled polyethylene terephthalate resin.
